(19) United States
(12) Patent Application Publication
(10) Pub. No.: US 2016/0083676 A1
(43) Pub. Date: Mar. 24, 2016

(54) METHOD AND APPARATUS FOR HIGH EFFICIENCY POST CMP CLEAN USING ENGINEERED VISCOUS FLUID

(71) Applicant: Applied Materials, Inc., Santa Clara, CA (US)

(72) Inventors: Ekaterina MIKHAYLICHENKO, San Jose, CA (US); Brian J. BROWN, Palo Alto, CA (US); Fred C. REDEKER, Fremont, CA (US)

(21) Appl. No.: 14/840,146

(22) Filed: Aug. 31, 2015

Related U.S. Application Data
(60) Provisional application No. 62/052,424, filed on Sep. 18, 2014.

(51) Int. Cl. C11D 17/00; B08B 1/00; B08B 3/12; C11D 3/04; C11D 1/14; C11D 3/20; C11D 3/37; B08B 3/04; B08B 3/02

(52) U.S. Cl. CPC C11D 17/0008; B08B 3/04; B08B 1/002; B08B 3/12; B08B 3/02; C11D 1/146; C11D 3/2041; C11D 3/3757; C11D 3/3769; C11D 3/044

(57) ABSTRACT

Embodiments of the present apparatus and methods for post CMP clean. More particularly, embodiments provide apparatus and methods for removing nano sized particles. One embodiment provides a method for cleaning a substrate. The method includes exposing the substrate to a viscoelastic fluid to remove small particles from the substrate. The viscoelastic fluid comprising a viscosity adjustor and an aqueous base.

### CROSS-REFERENCE TO RELATED APPLICATIONS

This application claims priority to U.S. Provisional Patent Application Ser. No. 62/052,424, filed on Sep. 18, 2014, which herein is incorporated by reference.

### BACKGROUND

1. Field

Embodiments of the present disclosure relate to methods and apparatus for removing particles from substrates after chemical mechanical polishing.

2. Description of the Related Art

After chemical mechanical polishing (CMP), substrates generally go through a post CMP cleaner where slurry particles and organic residues are removed. Typically, post CMP cleaner consists of several cleaning modules employing various particle removal technologies such as brush clean, high energy scrub clean, megasonic clean, fluid jet and others.

As the industry transitions to smaller nodes, it is desirable to remove smaller particles, such as nano sized particles (particles smaller than 100 nm), during post CMP cleaning because the size of defects, such as particles and scratches, in a substrate that can cause yield loss has become smaller and smaller. High number of nano particles may cause metal shorts, and thus, yield loss. Nano particles may also cause topography alternation and impact depth of focus in the subsequent lithography. Additionally, particles may agglomerate and get dislodged from the main surface or the bevel of the substrate and become embedded into the cleaning brush causing yield killing defect excursions.

However, removing nano sized particles represents a challenge. Nano sized particles are difficult to remove because nano sized particles may reattach to the substrate surface due to Van der Waal forces. A high energy scrubbing may be used prior to brush scrub to remove particles having a size of 120 nm or smaller. However, high energy scrubbing relies on high sheer force from the cleaning fluid and/or clean brushes to remove the particles. However, the sheer force may cause micro-scratching and other damage, particular when the substrate has soft films deposited thereon.

Therefore, there is a need for methods and apparatus to efficiently remove nano sized particles during post CMP clean.

### SUMMARY

Embodiments of the present apparatus and methods for post CMP clean. More particularly, embodiments provide apparatus and methods for removing nano sized particles.

In one embodiment, a method for cleaning a substrate is provided. The method includes exposing the substrate to a viscoelastic fluid to remove small particles from the substrate. The viscoelastic fluid comprising a viscosity adjustor and an aqueous base.

In another embodiment, a method for post CMP cleaning is provided. The method includes exposing the substrate to a viscoelastic fluid to remove small particles from the substrate and cleaning the substrate using at least one of a brush box, a rinsing station, a spray jet unit, a megasonic cleaner, or combinations thereof. The viscoelastic fluid comprising a viscosity adjustor, and an aqueous base.

In another embodiment, a viscoelastic fluid for cleaning a substrate is provided. The viscoelastic fluid comprises an aqueous base, a viscosity adjustor for increasing a viscosity of the viscoelastic fluid.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically illustrates a pre-clean process using a viscoelastic fluid according to one embodiment of the present disclosure.

FIG. 2 schematically illustrates a plan view of a post CMP cleaner according to one embodiment of the present disclosure.

FIG. 3 schematically illustrates a plan view of a post CMP cleaner according to another embodiment of the present disclosure.

FIG. 4 schematically illustrates a plan view of a post CMP cleaner according to another embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure describes methods for removing nano sized particles during post CMP cleaning. The present disclosure also describes a viscoelastic fluid for cleaning a substrate. In one embodiment, a viscoelastic fluid is applied to a substrate in a pre-clean module wherein the substrate is rotated. The viscoelastic fluid has a larger viscosity than traditional cleaning fluid. In one embodiment, an ultra soft cleaning pad is rotated in the pre-clean module. Methods of the present disclosure improve particle removing efficiency of post CMP cleaners without causing damage or micro-scratching by using the viscous engineered fluid and ultra soft polishing pad.

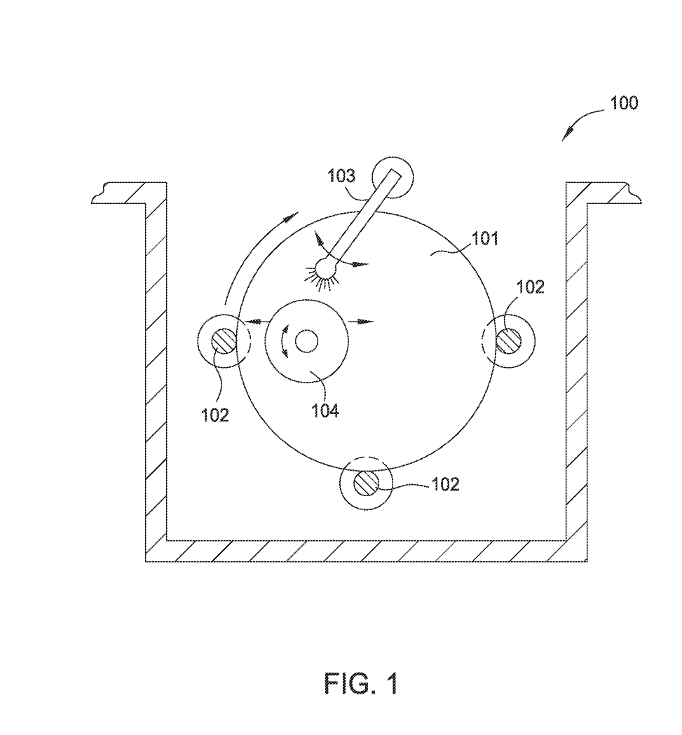

FIG. 1 schematically illustrates a pre-clean process using a viscoelastic fluid according to one embodiment of the present disclosure. The pre-clean process is configured to remove particles, including nano sized particles, from a substrate surface. The term “nano sized particles” refers to particles having a diameter of about 100 nm or smaller. The pre-clean process may be performed in a cleaning module 100. The cleaning module 100 in FIG. 1 is a vertical cleaning device, where a substrate 101 being processed is disposed in a substantially vertical orientation. The cleaning module 100 may include one or more rollers 102 for supporting and rotating the substrate 101. A nozzle 103 may be positioned to deliver a fluid flow towards the substrate 101. The nozzle 103 may be movable in the cleaning module 100 to cover an entire radius of the substrate 101 during processing. The cleaning module 100 may include a scrub disk 104 configured to clean the substrate 101. In one embodiment, the scrub disk 104 may be an ultra soft scrub disk that is softer than traditional scrub disks used in post CMP cleaning. The scrub disk 104 may be rotatable and movable along to cover the entire surface of the substrate 101. Alternatively, embodiments of the present disclosure may be used in cleaning apparatus of other configuration, for example, a horizontal cleaning module wherein a substrate is supported and rotated on a pedestal.

The substrate 101 being processed may be disposed in the cleaning module 100 to remove nano sized particles. In one embodiment, a viscoelastic fluid may be directed towards the substrate 101 while the substrate 101 is being rotated. The viscoelastic fluid may be a fluid that exhibits both viscous and elastic characteristics. The viscoelastic fluid applies a hydrodynamic drag force to the surface of the substrate 101 upon contact. Small particles, including nano sized particles, on the substrate 101 may be removed from the surface of the substrate 101 by the hydrodynamic drag force.

In one embodiment, the hydrodynamic drag force may be increased by applying a sheer force to the substrate 101 while the viscoelastic fluid is being delivered to the substrate 101. In one embodiment, the sheer force may be applied by relatively moving a cleaning pad against the substrate 101. For example, rotating the ultra soft scrub disk 104 against the substrate 101. The ultra soft scrub disk 104 may also move across the substrate 101 to scan the entire surface of the substrate 101. The combination of the hydrodynamic drag force from the viscoelastic fluid and the sheer force from the ultra soft scrub disk 104 effectively removes small particles, including nano sized particles, from the surface of the substrate 101.

In one embodiment, the sheer force may be applied from a cleaning pad, such as the ultra soft scrub disk 104, made from a material with low dynamic sheer modulus to minimize micro scratching from agglomerated particles. For example, the ultra soft scrub disk 104 may be made from a conformal material of low density and high porosity. In one embodiment, the ultra soft scrub disk 104 is formed from polyvinyl acetate (PVA).

The viscoelastic fluid according to the present disclosure has high viscosity and/or exhibits viscoelastic properties. In one embodiment, the viscoelastic fluid may have a viscoelastisity selected to entrain and/or sweep nano sized particles from the surface of the substrate. The viscoelastic fluid may be an aqueous based cleaning medium including one or both of a viscosity adjustor and an elasticity adjustor. In one embodiment, the aqueous base may be de-ionized water (DIW). For example, the aqueous base may be greater than 95% by weight of DIW. The viscosity and elasticity adjustor may include one or more high molecular weight polymer, such as but not limited to polyacrylamide (PAM), poly (methyl methacrylate) (PMMA), polyvinyl acetate (PVA), or combinations thereof. In one embodiment, the viscoelastic fluid may include one or more high molecular polymers. The viscosity adjustor and elasticity adjustor may further include a thickener, such as glycol.

In one embodiment, the viscoelastic fluid may also include one or more surfactants. An exemplary surfactant may be ammonium dodecyl sulfate, or similar chemical.

The viscoelastic fluid may include a pH adjustor according to material in on the surface of substrate being cleaned. For example, when cleaning a copper containing substrate, a high pH value is desired to produce a target surface finish. For example, the viscoelastic fluid may include ammonium hydroxide (NH₄OH) or tetramethylammonium hydroxide (TMAH).

The viscoelastic fluid may be blended to be compatible with the substrate surface so that there is minimal material loss during cleaning. For example, the viscoelastic fluid may be compatible with Cu, Co, W, Si, poly silicon, silicon oxide, and other materials on the substrate being processed.

The viscoelastic fluid may also be blended to have high trapping efficiency for particles, such as particles of SiO₂, SiN, Al₂O₃, CeO₂. For example, the viscoelastic fluid may be selected to achieve improved trapping efficiency.

In one embodiment, the viscoelastic fluid may include adders for removal of organic particles and residues, such as benzotrazole (BTA).

As discussed above, embodiments of the present disclosure provide a method for efficiently removing small particles, including nano sized particles, by flowing a viscoelastic fluid, such as the viscoelastic fluid discussed above, with viscoelastic on a substrate surface. The smaller particles may be removed by a hydrodynamic drag force applied to the substrate surface by the viscoelastic fluid. The viscoelastic fluid may be sprayed towards a rotating substrate to generate the hydrodynamic drag force. Alternatively, the substrate may be rotating in a bath of the viscoelastic fluid to remove small particles from the substrate. The viscoelastic fluid may be used alone without an external pad or brush contacting the substrate to remove particles. Optionally, a cleaning pad or brush may be applied to the substrate in combination with the viscoelastic fluid to increase particle removal rate. The cleaning pad may be an ultra soft pad to minimize scratching defects.

The cleaning process using viscoelastic fluid is generally followed by a rinse step to remove the viscoelastic fluid from the substrate being processed. For example, a rinse with DI water may be used after each cleaning process with viscoelastic fluid.

The methods of particle removal using viscoelastic fluid may be used for general substrate cleaning or in combination with other cleanings. In one embodiment, the viscoelastic fluid cleaning may be used in post CMP cleaning to improve particle removal rate in post CMP cleaning. The viscoelastic cleaning may be added to a traditional post CMP clean and/or used to replace or modify a traditional pre-clean process in a traditional post CMP clean.

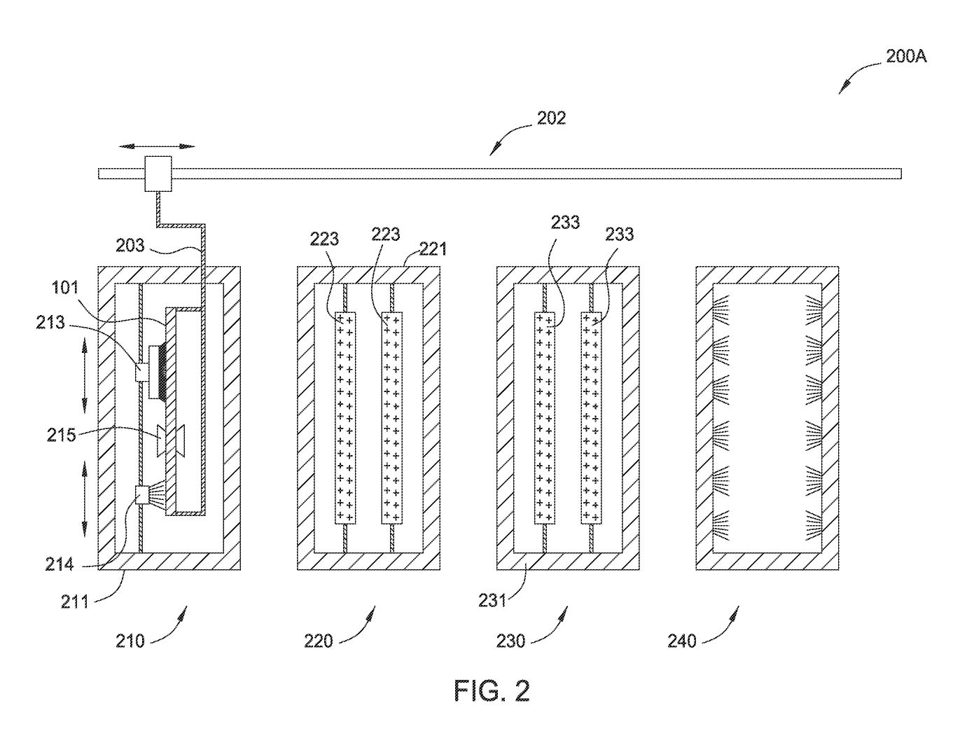

FIG. 2 schematically illustrates a plan view of a post CMP cleaning module 200A according to one embodiment of the present disclosure. The post CMP cleaning module 200A includes a cleaning station configured to perform a cleaning process using a viscoelastic fluid according to the present disclosure.

The post CMP cleaning module 200A may be employed to clean substrates after chemical mechanical polishing. The post CMP cleaning module 200A includes a plurality of cleaning stations 210, 220, 230 and a dryer 240. A substrate transfer module 202 is positioned to move one or more substrates 101 among the cleaning stations 210, 220, 230 and the dryer 240. The cleaning station 210 may be a pre-clean station configured to perform the cleaning process using the viscoelastic fluid according to the present disclosure. The cleaning stations 220, 230 may be scrubber brush boxes. A substrate handler 203 may be used to transfer the substrate 101 in and out the cleaning stations/dryer.

The pre-clean station 210 may include a tank 211, a disk brush 213 and a nozzle 214. The disk brush 213 may be movably disposed in the tank 211 so that the disk brush 213 may contact the substrate at an entire radius. The disk brush 213 may also rotate about its central axis. The nozzle 214 is configured to direct a cleaning fluid toward the substrate 101. In one embodiment, the nozzle 214 may be movably disposed in the tank 211 so that the fluid flow from the nozzle 214 may reach the entire radius of the substrate 101. The pre-clean station 210 may also include one or more rollers 215 to support and rotate the substrate 101 during processing. The nozzle 214 may be connected to a fluid source of the viscoelastic fluid described above. The disk brush 213 may include an ultra soft clean pad, such as a clean pad made from PVA. The pre-clean station 210 is configured to remove particles, including but not limited to slurry residue such as silica, alumina or the like, organic residue, such as benzotriazole (BTA) or the like, and/or other particles. The application of viscoelastic fluid and ultra soft clean pad in from the disk brush 213 improve particle removal ratio, particularly improve removal ratio of nano sized particles.

The scrubber brush boxes 220, 230 may clean relatively small particles from the substrate surface. The scrubber brush box 220 may include two roller brushes 223 disposed in a tank 221. The two roller brushes 223 rotate against back and front surfaces of the substrate being processed. The scrubber brush box 220 may be used to clean any copper oxide (CuxO) nodules or the like that may have formed on the substrate surface. Similarly, the scrubber brush box 230 may include two roller brushes 233 disposed in a tank 231.

The dryer 240 of the post CMP cleaning module 200A may be a spin-rinse dryer, which may include an isopropyl alcohol (IPA) vapor dryer (e.g., for Marangoni drying) or any other type of dryer. The dryer 240 shown in FIG. 2 is a tank-type Marangoni dryer.

In one embodiment, post CMP clean may be performed using the post CMP cleaning module 200A. First, a substrate completing a CMP process is transferred into the pre-clean station 210. The substrate is rotated by the rollers. The viscoelastic fluid may be sprayed against the substrate. The disk brush 213 may be rotating against the substrate while scanning a radius of the substrate. The viscoelastic fluid in contact with the substrate applies a hydrodynamic drag force that removes particles from the substrate. The ultra soft clean pad moves against the substrate generating sheer force to increase the hydrodynamic drag force and improve the particle removal rate. The ultra softness of the clean pad helps prevent generation of undesirable scratching defects.

In one embodiment, the pre-clean station 210 may include a second scrubber brush that is harder than the ultra soft scrubber in the disk brush 213. For example, the second scrubber brush may be formed of polytex or other suitable materials. After the cleaning using the viscoelastic fluid, a conventional pre-cleaning fluid, such as DI water or low pH chemistry (such as a pH range of about 2 to about 4), may be sprayed towards the substrate while the second scrubber brush rotates against the substrate.

After the pre-cleaning is performed in the pre-clean station 210, traditional post CMP cleaning processes may be performed to the substrate as the substrate moves along the cleaning stations in the post CMP cleaning module. For example, the substrate may be transferred to the brush box 220 wherein the substrate is scrubbed with a high pH chemistry (such as a pH vale greater than 7, for example, a pH range between about 11 to about 12.5) by roller brushes. The high pH chemistry scrubbing may remove remaining particles while forming an oxide layer and leaves a passive surface on any metal structure. The passive surface prevents formation of chemical bonds between the surface and loose particles. The substrate may be then transferred to the brush box 230 and is again scrubbed with high pH chemistry. The brush boxes 220, 230 may use different chemistry and/or different type of brushes to achieve a desired cleaning result. The substrate may then be transferred to the dryer 240 to get dried, for example by isopropyl alcohol (IPA) vapor.

Even though cleaning in two brush boxes is described in FIG. 2, combinations of various types of cleaning stations may be used according to the process recipe. For example, brush boxes, rinsing stations, spray jet units, megasonic cleaners, combinations thereof may be used to follow the pre-cleaning process to complete a post CMP cleaning.

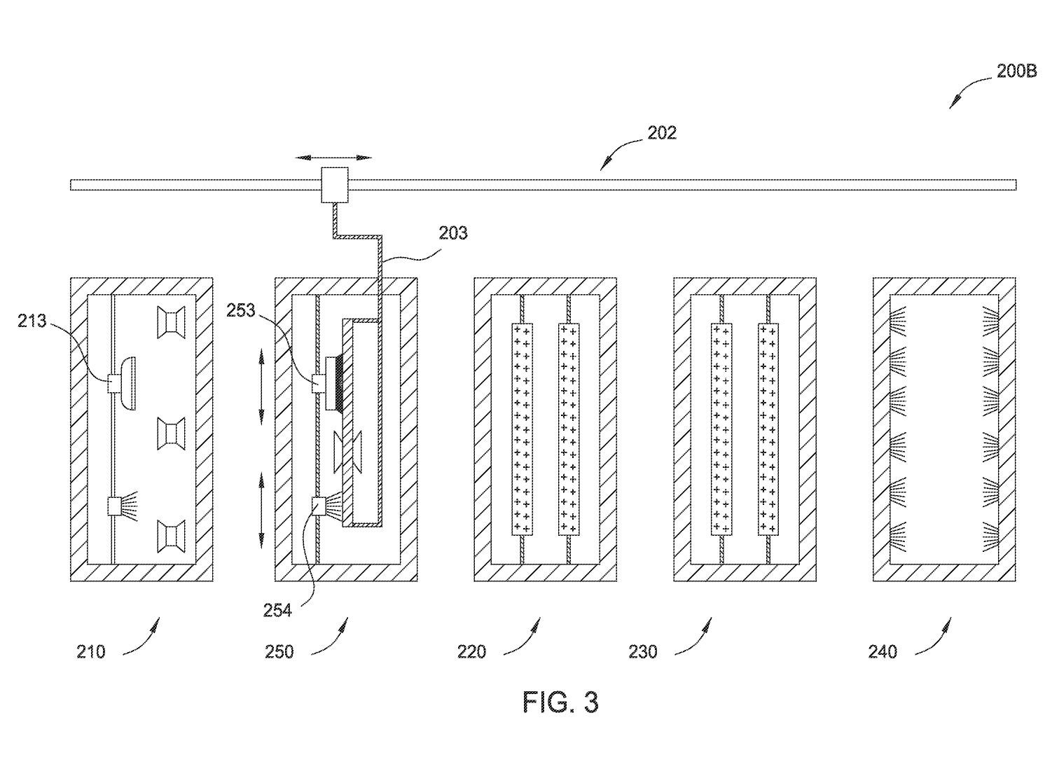

FIG. 3 schematically illustrates a plan view of a post CMP cleaning module 200B according to another embodiment of the present disclosure. The post CMP cleaning module 200B is similar to the post CMP cleaning module 200A except a second scrubber brush station 250 is positioned immediately after the pre-clean station 210. The second scrubber brush station 250 includes a scrubber brush 253 that is harder than the ultra soft scrubber in the disk brush 213 and a nozzle 254. The scrubber brush 253 may be made of polytex. After the cleaning using the viscoelastic fluid in the pre-clean station 210, a scrub cleaning may be performed in the second scrubber brush station 250 with a traditional cleaning fluid, such as DI water or low pH chemistry.

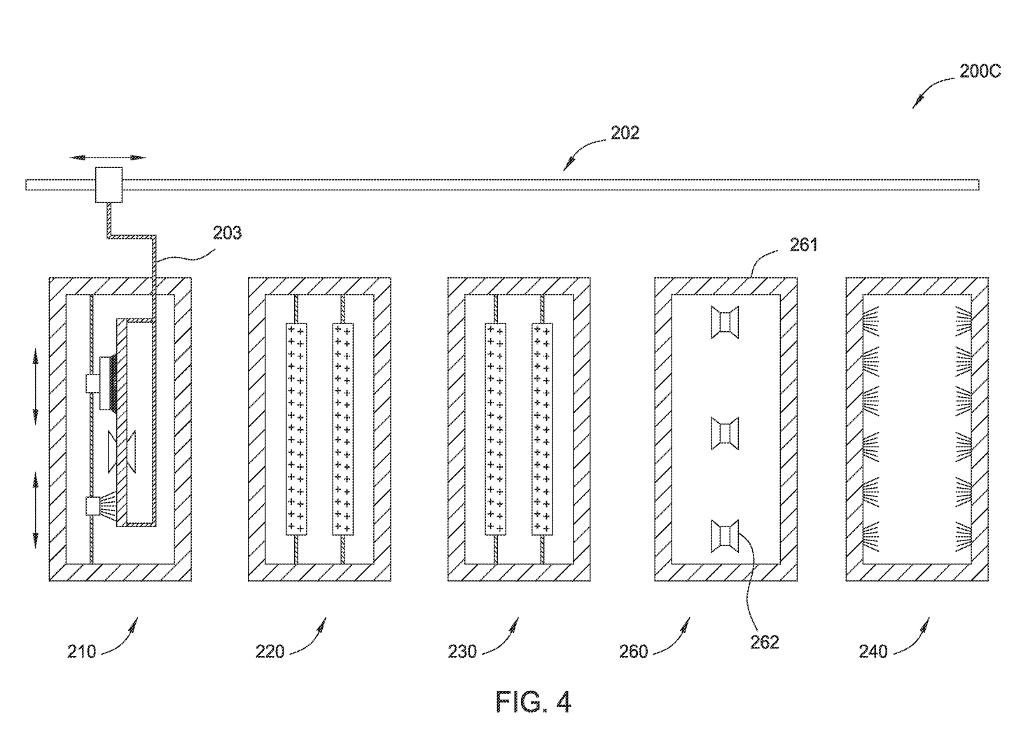

FIG. 4 schematically illustrates a plan view of a post CMP cleaning module 200C according to another embodiment of the present disclosure. The post CMP cleaning module 200C is similar to the post CMP cleaning module 200A except a non-contact viscoelastic cleaner 260 is positioned immediately before the dryer 240. The non-contact viscoelastic cleaner 260 may include a tank 261. Two or more rollers 262 may be positioned in the tank 261 to rotate the substrate in the tank. During processing, a conventional scrubbing clean or a pre-clean with the viscoelastic fluid may be performed in the pre-clean station 210. After intermediate cleaning processes are performed, for example in the brush boxes 220 and 230, the substrate may be transferred to the non-contact viscoelastic cleaner 260 to remove any remaining small particles. In one embodiment, the non-contact viscoelastic cleaner 260 may have a viscoelastic fluid bath in the tank 261, and the substrate may be cleaned by rotating in the viscoelastic fluid bath. In another embodiment, the viscoelastic fluid may be sprayed towards the substrate while the substrate is being rotated by the rollers 262. Alternatively, the non-contact viscoelastic cleaner may be combined with the dryer 240.

It should be noted that even cleaning processes with viscoelastic fluid described above may be followed by a rinse step to remove the viscoelastic fluid. The rinse may be performed by spraying DI water towards the substrate.

Using the viscoelastic fluid to pre-clean substrates has several advantages. Using the viscoelastic fluid allows reducing the sheer force provided by cleaning pads or scrubber brushes. Instead of relying on down force from the cleaning pads or brushes to provide sheer force, the sheer force is provided by the viscoelastic fluid. Lower down force reduces the risk of micro scratching due to the dislodged particles. Using viscoelastic fluid also reduces the chance for the dislodged particles to get imbedded in cleaning pads or brushes.

Using the viscoelastic fluid in a post CMP clean reduces the defect counts on substrates after CMP process. Performing a cleaning process using the viscoelastic fluid during post CMP clean prevents micro scratching caused by dislodged agglomerated slurry particles in the presence of high pad down force. Performing a cleaning process using the viscoelastic fluid during post CMP clean also improves particle removing efficiency. Performing a cleaning process using the viscoelastic fluid during post CMP clean prevents dislodged particles from embedding into the cleaning brushes/pads, thus extending the service life of the brush and reducing cost.

Even though the above embodiments are described in association with post CMP cleaning, the engineered fluid and/or ultra soft pad according to the present disclosure may be implemented any suitable substrate cleaning process.

While the foregoing is directed to embodiments of the present disclosure, other and further embodiments of the disclosure may be devised without departing from the basic scope thereof, and the scope thereof is determined by the claims that follow.

1. A method for cleaning a substrate, comprising:
exposing the substrate to a viscoelastic fluid to remove small particles from the substrate, wherein the viscoelastic fluid comprising:
a viscosity adjustor; and
an aqueous base.

2. The method of claim 1, wherein exposing the substrate to the viscoelastic fluid comprises rotating the substrate while spraying the viscoelastic fluid towards the substrate.

3. The method of claim 2, further comprising:
rotating a disk brush against the surface of the substrate.

4. The method of claim 3, wherein the disk brush is made of polyvinyl acetate.

5. The method of claim 1, wherein exposing the substrate to the viscoelastic fluid comprising rotating the substrate in a bath of the viscoelastic fluid.

6. A method for post CMP cleaning, comprising:
exposing the substrate to a viscoelastic fluid to remove small particles from the substrate, wherein the viscoelastic fluid comprising:
a viscosity adjustor; and
an aqueous base; and
cleaning the substrate using at least one of a brush box, a rinsing station, a spray jet unit, a megasonic cleaner, or combinations thereof.

7. The method of claim 6, wherein exposing the substrate to the viscoelastic fluid comprises pre-cleaning the substrate in a pre-clean station before cleaning the substrate.

8. The method of claim 7, further comprising rotating an ultra soft scrubber disk against the substrate while spraying the viscoelastic fluid towards the substrate.

9. The method of claim 6, wherein exposing the substrate to a viscoelastic fluid is performed after cleaning the substrate.

10. A viscoelastic fluid for cleaning a substrate, comprising:
an aqueous base; and
a viscosity adjustor for increasing a viscosity of the viscoelastic fluid.

11. The viscoelastic fluid of claim 10, wherein the viscosity adjustor comprises a polymer.

12. The viscoelastic fluid of claim 11, wherein the polymer comprises polyacrylamide (PAM), poly (methyl methacrylate) (PMMA), polyvinyl acetate (PVA), or combinations thereof.

13. The viscoelastic fluid of claim 11, wherein the viscosity adjustor further comprises a thickener.

14. The viscoelastic fluid of claim 13, wherein the thickener comprises glycol.

15. The viscoelastic fluid of claim 10, wherein the aqueous base is DI water.

16. The viscoelastic fluid of claim 15, wherein the DI water is about 95% by weight.

17. The viscoelastic fluid of claim 10, further comprising a pH adjustor.

18. The viscoelastic fluid of claim 17, wherein the pH adjustor comprises one of ammonium hydroxide (NH₄OH) and tetramethylammonium hydroxide (TMAH).

19. The viscoelastic fluid of claim 10, further comprising a surfactant.

20. The viscoelastic fluid of claim 19, wherein the surfactant is ammonium dodecyl sulfate.
